(19) United States
(12) Patent Application Publication
(10) Pub. No.: US 2004/0260681 A1
(43) Pub. Date: Dec. 23, 2004

(54) Method and system for selectively retrieving text strings

(76) Inventor: Joseph L. Dvorak, Boca Raton, FL (US)

Correspondence Address: PABLO MELES, ESQ., AKERMAN SENTERFITT, 222 Lakeview Avenue, 4th Floor, P.O. Box 3188, West Palm Beach, FL, 33402-3188, US

(21) Appl. No.: 10/465,095

(22) Filed: Jun. 19, 2003

(51) Int. Cl. G06F 7/00

(52) U.S. Cl. 707/3

(57) ABSTRACT

A method (50) and system(10) for selectively retrieving text strings from a plurality of stored text strings contained on a data storage medium accessible by a processor (12) can include a data input device (18) providing a query to the processor. The processor can be programmed to receive (52) the query, determine a number of significant words in the query (54), determine a number of significant words in a candidate text string (56), determine a number of matches between the significant words in the query and the candidate text string (58), and compute a match score (60) for each candidate text string using the number of significant words in the query, the number of significant words in the candidate text string, and the number of matches. The system can further include a speaker (21) or a display device (22) rendering (68 or 69) at least one candidate text string having the largest match score.

### CROSS-REFERENCE TO RELATED APPLICATIONS

Not applicable

### FIELD OF THE INVENTION

This invention relates generally to text string matching, and more particularly to a system and method for retrieving text string matches.

### BACKGROUND OF THE INVENTION

In voice driven applications, a user may need to find a specific piece of textual information. The user may be able to remember only part of the words in the string and may not remember them in the order in which they appear in the string. Additionally, the user may use certain words such as “a”, “the”, “of”, etc. in constructing a query using natural language. These “insignificant words” convey very little meaning and unnecessarily complicate the selection process for retrieving text strings that substantially match a user requested text string.

Voice driven applications typically suffer from several problems including ambiguity. In a physical interaction involving a mouse or other pointing device, users specify the focus of their actions directly by clicking on the item of interest. Using a keyboard as an input device may also suffer from other ambiguities that are not necessarily inherent with voice driven applications. Ambiguities caused by items that have the same name can be resolved through the physical interaction available with keyboards and mice. With speech, users do not have a way to resolve ambiguities physically and therefore the ambiguity must be prevented somehow or some other method must be used to perform the resolution.

Efficiency is another problem in speech interfaces. It can take quite a bit longer to select a target by voice than to point and click. To allow this, speech interfaces must increase efficiency by keeping required commands short and reducing the total number of commands. A method for retrieving text strings using voice commands would likely need to strike a balance between efficiency and the need to reduce ambiguities and complexity.

Portable handheld devices such as mobile phones, personal digital assistants, and even laptop computers may have limited processing resources that can certainly do without complicated textual searching engines. With the advent of better voice recognition systems, more and more portable handheld devices will likely include speech-to-text applications that will need to perform functions flexibly using natural speech as input. Existing textual search schemes are much too complicated and processor intensive for practical use in portable handheld devices. Below are examples of such schemes.

U.S. Pat. No. 5,606,690, entitled “Non-literal textual search using fuzzy finite non-deterministic automata” issued Feb. 25, 1997 and assigned to Canon discusses selectively retrieving information contained in a stored document set using a metric-based or “fuzzy” finite-state non-deterministic automaton. An automaton is constructed corresponding to a text string query, text strings are read from storage and corresponding dissimilarity values are generated. Those strings resulting in values less than a given threshold are recorded and listed for the user. Dissimilarity values are determined based on penalties associated with missing characters, extra characters, incorrect characters, and other differences between the text string query and a text string read from storage.

U.S. Pat. No. 5,600,835, entitled “Adaptive non-literal text string retrieval” issued Feb. 4, 1997 and assigned to Canon discusses selectively retrieving information contained in a stored document set using a non-literal, or “fuzzy”, search strategy. A text string query is transmitted to a computer processor, and a dissimilarity value D(i) is assigned to selected ones of stored text strings representative of information contained in a stored document set, based upon a first set of rules. A set of retrieved text strings representative of stored information and related to the text string query is generated, based upon a second set of rules. Each of the retrieved text strings has an associated dissimilarity value D(i), which is a function of at least one rule R(n) from the first set of rules used to retrieve the text string and a weight value w(n) associated with that rule R(n). The retrieved text strings are displayed preferably in an order based on their associated dissimilarity value D(i). Once one or more of the retrieved text strings is chosen, the weight value w(n) associated with at least one rule of the first set of rules is adjusted and stored. The Canon text retrieval and searching systems described above are much too complicated and would likely get bogged down in unnecessary processing when using natural language as input.

Thus, a relatively simple alternative system and method of text matching and text retrieval that overcomes the detriments described above would likely be suitable for handheld portable devices and other devices that ultimately use text input in queries.

### SUMMARY OF THE INVENTION

A method and system for matching and retrieving textual information using a relaxed matching algorithm provides a high degree of accuracy while accommodating the impreciseness of a user's query that may also be inherent in the natural language used to make such query. Ideally, the algorithm is simple and uses a reduced amount of resources in terms of processing power and memory requirements.

In a first aspect of the present invention, a method for selectively retrieving text strings from a plurality of stored text strings stored on a data storage medium accessible by a processor can include the steps of receiving a query having a user-defined text string, determining a number of words in the query, determining a number of words in a candidate text string, and determining a number of matches between the words in the query and the candidate text string. The method can further include the step of computing a match score for each candidate text string using the number of words in the query, the number of words in the candidate text string, and the number of matches. Additionally, the method can further include the steps of selecting at least one candidate text string having among one of the largest match scores and rendering at least one candidate text string having the largest match score. Rendering can include providing an audio output using text-to-speech synthesis, a display or other human interpretable output. The plurality of stored text stings can be stored in a database, a document, a file or in any other manner within the data storage medium. Furthermore, all the steps of determining a number of words described above can be steps of determining a number of significant words as will be further detailed below.

In a second aspect of the present invention, a processor-based system for selectively retrieving text strings from a plurality of stored text strings stored on a data storage medium accessible by a processor can include a data input device providing a query having a user-defined text string to the processor. The processor can be programmed to receive the query, determine a number of words in the query, determine a number of words in a candidate text string from the file, determine a number of matches between the words in the query and the candidate text string from the file, and compute a match score for each candidate text string using the number of words in the query, the number of words in the candidate text string, and the number of matches. The system can further include a rendering device for providing an audio output or displaying at least one candidate text string having among the largest match scores. The system can be a laptop computer, a desktop computer, a personal digital assistant, a mobile telephone, an electronic book, a smart phone, or a portable handheld computing/communication device.

In yet another aspect, an embodiment of the present invention can include a machine-readable storage having stored thereon a computer program having a plurality of code sections executable by a machine for causing the machine to perform the steps described above in the method of the first aspect of the invention.

### BRIEF DESCRIPTION OF THE DRAWINGS

FIG. 1 is a block diagram of a system in the form of a portable communication device using a method of selectively retrieving text strings in accordance with the present invention.

FIG. 2 is a flow chart illustrating a method of selectively retrieving text strings in accordance with the present invention.

FIG. 3 is a flow chart illustrating another method of selectively retrieving text strings in accordance with the present invention.

### DETAILED DESCRIPTION OF THE DRAWINGS

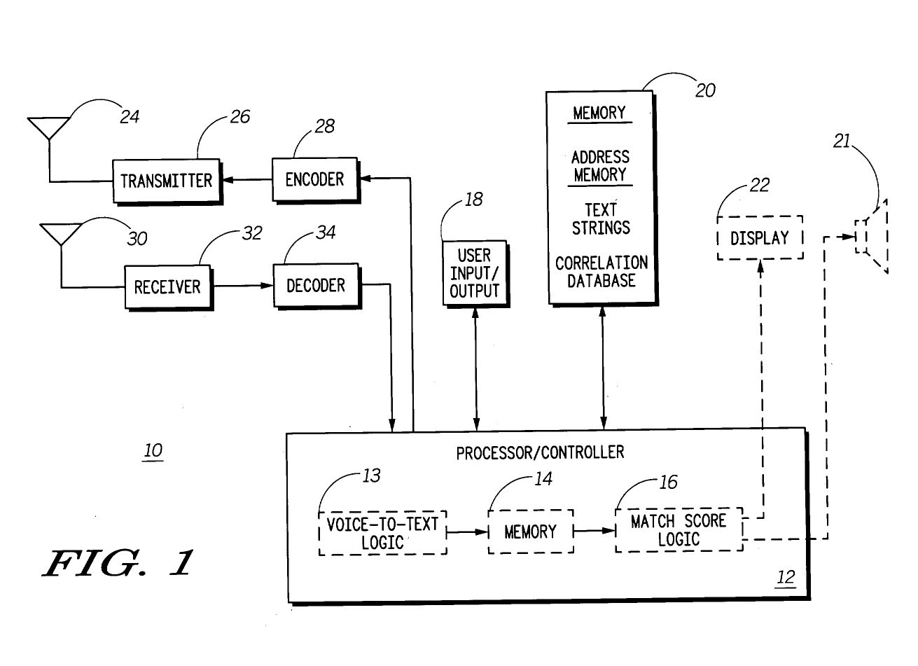

Referring to FIG. 1, a processor-based system 10 illustrates an embodiment in accordance with the present invention. The system 10 can be a laptop computer, a desktop computer, a personal digital assistant, a mobile telephone, an electronic book, a smart phone, a communication controller, or a portable handheld computing/communication device. A communication controller can be a device that does not (by itself) directly provide a human recognizable output and does not necessarily include a display, speaker, or other output device. This embodiment in particular illustrates a mobile telephone having a means for selectively retrieving text strings from a plurality of stored text strings which can be contained in a database, a file, a document or otherwise stored on a data storage medium 20 or 14 accessible by a processor 12, or via the Internet or remote server. The system 10 can include a user input/output device 18 such as a data input device providing a query having a user-defined text string to the processor 12. The input device 18 can be a microphone for receiving voice instructions that can be transcribed to text using voice-to-text logic 13 for example. Of course, input device 18 can also be a keyboard or Graphical User Interface for entering text. The processor 12 can be programmed to receive the query, determine a number of significant words in the query, determine a number of significant words in a candidate text string from the file, determine a number of matches between the significant words in the query and the candidate text string from the file, and compute a match score for each candidate text string using the number of significant words in the query, the number of significant words in the candidate text string, and the number of matches. The logic for computing the match score can be a module 16 residing within the processor 12, although the present invention is not limited thereto. The system 10 can further optionally include a rendering or output device such as speaker 21 or display device 22 for audibly producing or displaying respectively at least one candidate text string having among the largest match scores. Since the system 10 can be a mobile telephone, it can also include a voice encoder 28, a transmitter 28 and an antenna 24 for transmitting as well as an antenna 30 for receiving, a receiver 32 and a decoder 34. Of course, the mobile telephone could use a single antenna for both receiving and transmitting and can otherwise be constructed in numerous configurations known to those skilled in the art.

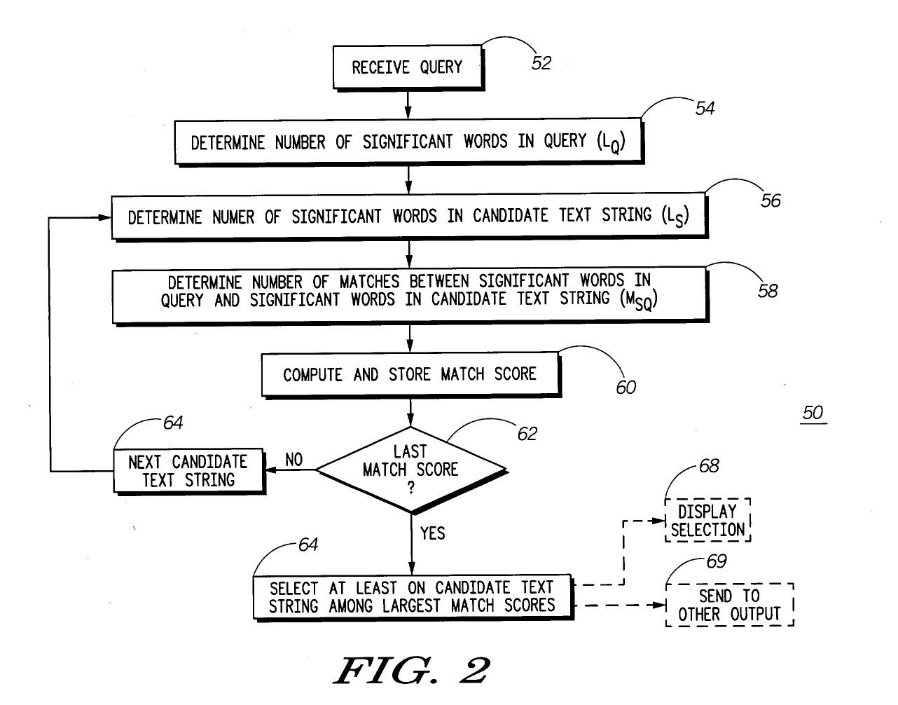

Referring to FIG. 2, a flow chart illustrates an exemplary method 50 for selectively retrieving text strings from a plurality of stored text strings stored on a data storage medium or remote server accessible by a processor. The method 50 can include the steps of receiving a query having a user-defined text string at step 52, determining a number of significant words in the query at step 54, determining a number of significant words in a candidate text string from the file at step 56, and determining and storing a number of matches between the significant words in the query and the candidate text string at step 58. The method 50 can further include the step of computing a match score at step 60 for each candidate text string using the number of significant words in the query (L_{Q}), the number of significant words in the candidate text string (L_{S}), and the number of matches (M_{QS}). The method 50 can proceed by determining at decision block 62 if all the candidate text strings in a file (or a document or a database) were analyzed. The next candidate text string is queued up for analyzing at step 64 if there are additional candidate text strings at decision block 62. If there are no further candidate text strings at decision block 62, the method 50 can further include the step 64 of selecting at least one candidate text string having among one of the largest match scores and optionally displaying the selection(s) at step 68 or optionally sending the selection(s) to some other output device at step 69. The selection can be at least one or more candidate text strings having among the largest match scores. Preferably, the method can just select the candidate text string having the largest match score. Further note that the method 50 does not necessarily require determining a number of significant words in the query and candidate text strings. The method can also just look at the number of words (significant or otherwise) and still compute a match score as will become further apparent below.

The process of computing the match score can preferably use a relaxed match scheme that selects a text string from among a number of unique text strings that maximizes the proportion of significant words of the query and the proportion of significant words in the text string that are matched. Although not necessarily required, the ratio can be normalized so that the match score has a range of 0 to 1 inclusive. The algorithm computes a match score for each query-candidate text string comparison. The match score can be defined as:

Match Score:=(M_{Q}/L_{Q})*(M_{S}/L_{S})

where:

M_{Q}=number of significant words in query text string that matched

L_{Q}=number of words in query text string

M_{S}=number of significant words in candidate text string matched

L_{S}=number of words in candidate text string

Note that in most instances, if not all instances, M_{Q}=M_{S}

The relaxed match scheme can (although does not necessarily have to) make a distinction between significant and insignificant words. Insignificant words can be defined as words that carry little defining information. These can include “a”, “the”, and “an” for example. Significant words can be any words not defined as insignificant. The set of insignificant words can be specified by the application employing the algorithm and can optionally be specified or customized by a user. In one embodiment, the set of insignificant words can be set to be empty, in which case, all words would be considered significant. When a text string in a group of strings being searched is compared with the words in the query, the relaxed match algorithm can compute the match score ignoring the insignificant words in the query. L_{Q} and L_{S} can be computed ignoring the occurrence of insignificant words as well. The text string with the largest match score is then selected.

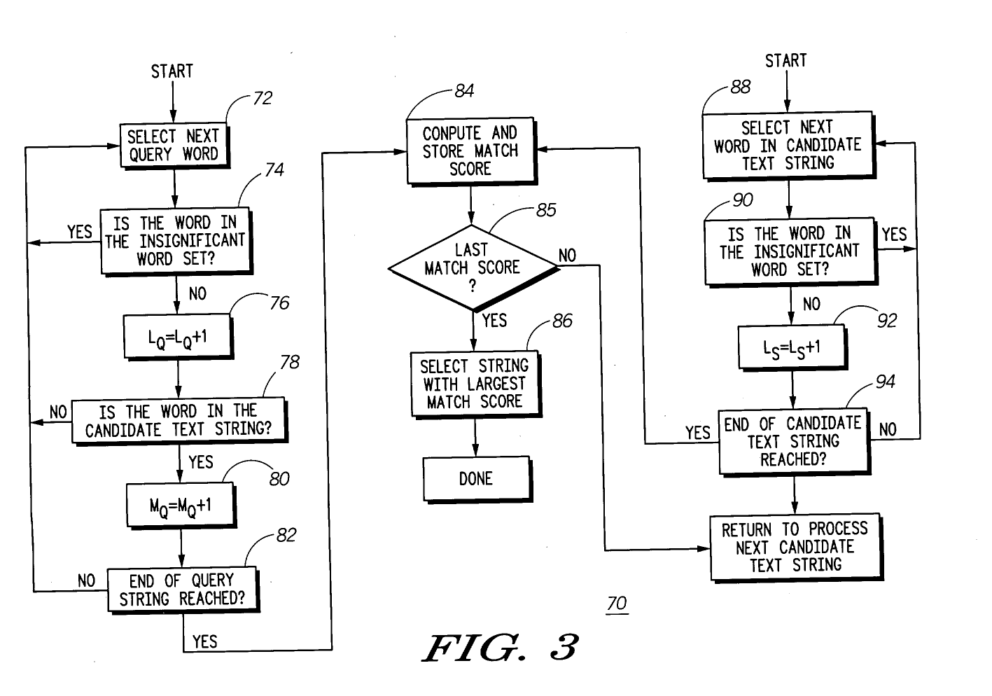

Referring to FIG. 3, another flow chart illustrating a method 70 having the relaxed scheme as explained above is shown. The method 70 can include the step of receiving a query having a user-defined text string and selecting a word in the query at step 72. The word in the query is compared with an insignificant word set at step 74. If the word from the query matches a word in the insignificant word set at step 74, then the next query word is selected for comparison. If the word from the query is not in the insignificant word set, then it is “significant” and the number of significant words in the query L_{Q} is incremented at step 76. At step 78, it is determined if the current word in the query has a match with a word in the candidate text string. If there are no matches at step 78, the next word in the query is selected at step 72. If the current word from the query matches a word in the candidate text string at step 78, the number of matches M_{Q} is incremented at step 80. Steps 72 through 80 are repeated until all the significant words in a query are analyzed as indicated at step 82.

Before the method 70 proceeds to computing a match score at step 84, the method 70 can similarly determine the number L_{S} of significant words in a candidate text string. This determination can be done for each candidate text string in a file or document. For each candidate text string, the method 70 selects the word in the candidate text string at step 88. The word in the current candidate text string is compared with an insignificant word set at step 90. If the word from the current candidate text string matches a word in the insignificant word set at step 90, then the next word in the current candidate text string is selected for comparison back at step 88. If the word from the current candidate text string is not in the insignificant word set, then it is “significant” and the number L_{S} of significant words in the candidate text string is incremented at step 92. Steps 88 through 92 repeat until all the significant words in the candidate text string are counted as indicated at step 94. Now that the method 70 has determined the number of significant words in the query and the candidate text string as well as the number of matching significant words between the two, the method 70 can compute a match score at step 84. If the match score is the last match score computed for the candidate text strings in the file or document at decision block 85, the candidate text string with the largest match score can be selected at step 86. As previously mentioned, the method can also select a predetermined number of candidate text strings having among the largest of match scores. If the match score computed at step 84 is not the last match score computed in the document or file, decision block 85 directs the method to return to process the next candidate text string in the document or file.

As an example, below is the text of a hypothetical user query. Below the hypothetical user query are several text strings to which it will be compared. Significant words are in bold, matched significant words are underlined. After each text string is its match score using the exemplary formula of:

Match Score:=(M_{Q}/L_{Q})*(M_{S}/L_{S})=(M_{QS})²/(L_{Q}*L_{S})

User Query: pick the cook book at the library

Candidate Text String 1: pick up the Italian cook book at the library

Match Score: (#matches/#significant words in query)*(#inatches/#significant words in candidate text)

Match Score: (4/4)*(4/6)=0.67

Candidate Text String 2: get the Greek book from Tom

Match Score: (¼)*(⅕)=0.05

Candidate Text String 3: pick up the text book at the store

Match Score: (2/4)*(⅖)=0.20

In the example above, text string 1, with a score of 0.67 would be selected. In addition, since the order of the words in the query does not matter, the following specifications would also select text string 1:

pick at the library the cook book

at the library, pick the cook book

In light of the foregoing description of the invention, it should be recognized that the present invention can be realized in hardware, software, or a combination of hardware and software. A method and system for selectively retrieving text strings according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

What is claimed is:

1. A method for selectively retrieving text strings from a plurality of stored text strings stored on a data storage medium accessible by a processor, comprising the processor steps of:
receiving a query having a user-defined text string;
determining a number of words in the query;
determining a number of words in a candidate text string from the file;
determining a number of matches between the words in the query and the candidate text string from the file; and
computing a match score for each candidate text string using the number of words in the query, the number of words in the candidate text string, and the number of matches.

2. The method of claim 1, wherein the method further comprises the step of selecting at least one candidate text string having the largest match score.

3. The method of claim 1, wherein the method further comprises the step of selecting at least one candidate text string having among one of the largest match scores.

4. The method claim 2, wherein the method further comprises the step of rendering the at least one candidate text string having the largest match score.

5. The method of claim 1, wherein the step of determining the number of words in the query comprises the step of determining the number of significant words in the query by comparing each word in the query with words in an insignificant word set.

6. The method of claim 1, wherein the step of determining the number of words in the candidate text string comprises the step of determining the number of significant words in the candidate text string by comparing each word in the candidate text string with words in an insignificant word set.

7. The method of claim 1, wherein the step of computing the match score comprises the step of dividing the number of matches squared by the result of the number of words in the query times the number of words in the candidate text string.

8. The method of claim 1, wherein the method further comprises the step of selecting the candidate text string by seeking for a text string having at least one match and a threshold number of significant words.

9. A processor-based system for selectively retrieving text strings from a plurality of stored text strings stored on a data storage medium accessible by a processor, the system comprising:
a data input device providing a query having a user-defined text string to the processor, wherein the processor is programmed to:
receive the query;
determine a number of words in the query;
determine a number of words in a candidate text string from the file;
determine a number of matches between the words in the query and the candidate text string from the file; and
compute a match score for each candidate text string using the number of words in the query, the number of words in the candidate text string, and the number of matches.

10. The system of claim 9, wherein the processor is programmed to select at least one candidate text string having the largest match score.

11. The system of claim 9, wherein the processor is further programmed to compare each word in the query with words in an insignificant word set to determine a number of significant words in the query and wherein the processor is further programmed to compare each word in the candidate text string with words in the insignificant word set to determine a number of significant words in the candidate text string.

12. The system of claim 9, wherein the processor is further programmed to divide the number of matches squared by the result of the number of words in the query times the number of words in the candidate text string to compute the match score.

13. The system of claim 9, wherein the processor is further programmed to select the candidate text string by seeking for a text string having at least one match and a threshold number of significant words.

14. The system of claim 9, wherein the system further comprises a user interface allowing a user to select at least one candidate text string among several candidate text strings having among the largest match scores.

15. The processor-based system of claim 9, wherein the processor-based system is selected among the group of devices comprising a laptop computer, a desktop computer, a personal digital assistant, a mobile telephone, an electronic book, a smart phone, a communication controller and a portable handheld computing/communication device.

16. The processor-based system of claim 9, wherein the processor-based system further comprises a rendering device selected from the group comprising a display device and a speaker for rendering at least one candidate text string having among the largest match scores.

17. A machine-readable storage, having stored thereon a computer program having a plurality of code sections executable by a machine for causing the machine to perform the steps of:
receiving a query having a user-defined text string;
determining a number of words in the query;
determining a number of words in a candidate text string from the file;
determining a number of matches between the words in the query and the candidate text string from the file; and
computing a match score for each candidate text string using the number of words in the query, the number of words in the candidate text string, and the number of matches.

18. The machine-readable storage of claim 17, wherein the machine-readable storage has code sections executable by the machine for causing the machine to select at least one candidate text string having among one of the largest match scores.

19. The machine-readable storage of claim 17, wherein the machine-readable storage has code sections executable by the machine for causing the machine to determine the number of words in the query and in the candidate text string by comparing each word in the query and candidate text string respectively with words in an insignificant word set.

20. The machine-readable storage of claim 17, wherein the machine-readable storage has code sections executable by the machine for causing the machine to compute the match score by dividing the number of matches squared by the result of the number of words in the query times the number of words in the candidate text string.

21. The machine-readable storage of claim 17, wherein the machine-readable storage has code sections executable by the machine for causing the machine to select the candidate text string by seeking for a text string having at least one match and a threshold number of significant words.
